(19) United States
(12) Patent Application Publication
(10) Pub. No.: US 2026/0200468 A1
(43) Pub. Date: Jul. 16, 2026

(54) AUTONOMOUS VEHICLE AND METHOD OF COMPENSATING STEERING ERROR THEREOF

(71) Applicants: Hyundai Motor Company, Seoul (KR); Kia Corporation, Seoul (KR)

(72) Inventor: Chan Il PARK, Hwaseong-Si (KR)

(21) Appl. No.: 19/293,794

(22) Filed: Aug. 7, 2025

(30) Foreign Application Priority Data
Dec. 17, 2024 (KR) 10-2024-0188796

(51) Int. Cl. B60W 30/12; B60W 50/00; B60W 60/00

(52) U.S. Cl. CPC B60W 30/12; B60W 50/0098; B60W 60/0053; B60W 2050/0026; B60W 2422/50; B60W 2510/202; B60W 2520/10; B60W 2520/14; B60W 2556/25; B60W 2710/202; B60W 2710/207

(57) ABSTRACT

An apparatus of a vehicle comprises a processor and a memory storing at least one instruction that, when executed by the processor communicating with the memory, causes the apparatus to determine, based on motion data of the vehicle and road information about a lane, a steering angle required for the vehicle, driving autonomously, to follow the lane, obtain an estimated steering error associated with the steering angle, adjust, based on the estimated steering error, the steering angle, output a signal indicating a difference between the adjusted steering angle and a measured steering angle of the vehicle, and control, based on the signal, a steering operation of the vehicle for transitioning from the driving autonomously to manually by a driver of the vehicle.

### CROSS-REFERENCE TO RELATED APPLICATION

This application claims the benefit of priority to Korean Patent Application No. 10-2024-0188796, filed in the Korean Intellectual Property Office on Dec. 17, 2024, the entire contents of which are hereby incorporated herein by reference.

### TECHNICAL FIELD

The present disclosure relates to an autonomous vehicle and a method of compensating steering error therein, and more specifically, to an autonomous vehicle and a method of compensating steering error therein to reduce or minimize performance degradation that occurs during steering override and simultaneously secure system stability.

### BACKGROUND

The matters described in this Background section are only for enhancement of understanding of the background of the disclosure, and should not be taken as acknowledgment that they correspond to prior art already known to those skilled in the art.

Vehicles may be equipped with autonomous driving systems to provide safety for reducing traffic accidents, traffic efficiency on roads, environmental friendliness through fuel savings, and convenience.

Autonomous driving systems may use technologies that recognize lanes using cameras and perform automatic steering, and measure a lane width, the lateral position of a vehicle in a lane, a distance between lanes, the shape of the lane, and the radius of curvature of a road on the basis of image processing of cameras. In addition, autonomous driving systems may also provide functions such as Smart Cruise Control (SCC) that estimates a driving trajectory of a vehicle using measured vehicle locations and road information and changes lanes along the estimated driving trajectory.

When an autonomous vehicle travels in a curved direction rather than a straight direction, the steering angle may be controlled using a torque utilization rate. At this time, it is necessary to improve performance through autonomous lateral control based on the steering angle and to adjust the torque utilization rate such that control may be smoothly transferred to the driver at the time of overriding.

However, steering angle control of conventional autonomous vehicles may have the following problems.

When the torque utilization rate is lowered, the steering of a vehicle may become softer, and thus steering feels more natural to the driver. However, steering angle control performance may be reduced, and thus the vehicle may not be accurately steered along a desired path in autonomous driving.

Increasing the torque utilization rate may improve the steering angle control performance, allowing the vehicle to be accurately steered along a desired path in autonomous driving. However, the steering may become stiff, which may cause discomfort to the driver when overriding steering.

### SUMMARY

Accordingly, the present disclosure is directed to an autonomous vehicle and a method of compensating steering error therein that substantially obviate one or more problems.

An object of the present disclosure is to secure control performance even in a smooth steering state when controlling a steering angle in an autonomous vehicle.

Additional advantages, objects, and features of the present disclosure will be set forth in part in the description which follows and in part will become apparent to those having ordinary skill in the art upon examination of the following or may be learned from practice of the present disclosure. The objectives and other advantages of the present disclosure may be realized and attained by the structure particularly pointed out in the written description and claims hereof as well as the appended drawings.

According to the present disclosure, an apparatus of a vehicle, the apparatus may comprise a processor and a memory storing at least one instruction that, when executed by the processor communicating with the memory, is configured to cause the apparatus to obtain a motion signal of the vehicle and recognition information of a front area of the vehicle, determine, based on the motion signal and the recognition information, a required steering angle for the vehicle and an estimated error value in the required steering angle, generate, based on the estimated error value, a tracking torque, wherein the tracking torque is a torque for the vehicle to follow the required steering angle, obtain a driver assist torque and a steering angle control torque ratio, generate an integrated steering torque based on the tracking torque, the driver assist torque, and the steering angle control torque ratio, and during a driving operation of the vehicle, provide the integrated steering torque as a rotational torque to front wheels of the vehicle.

The apparatus, wherein the steering angle control torque ratio is used to adjust a contribution ratio between the tracking torque and the driver assist torque for generating the integrated steering torque.

The apparatus, wherein the estimated error value is generated based on path curvature information obtained from the recognition information of the front area of the vehicle, and wherein the required steering angle is determined based on the path curvature information and the motion signal of the vehicle.

The apparatus, wherein the estimated error value is retrieved from a lookup table indexed by the required steering angle and a torque utilization rate, and the torque utilization rate is a ratio of the tracking torque to a sum of the tracking torque and the driver assist torque.

The apparatus, wherein the at least one instruction that, when executed by the processor communicating with the memory, is configured to cause the apparatus to obtain an error value by subtracting a steering angle value from a sum of a value of the required steering angle and the estimated error value, wherein the steering angle value is measured from front wheels of the vehicle, and adjust, based on the error value, the tracking torque.

The apparatus, wherein the driver assist torque is obtained based on a torque applied to a steering wheel of the vehicle by a driver of the vehicle.

According to the present disclosure, a method performed by an apparatus of a vehicle, the method may comprise obtaining steering error data of the vehicle, wherein the steering error data is associated with a plurality of torque utilization rates and a plurality of required steering angles, generating, based on the obtained steering error data, a table, wherein the table associates a torque utilization rate of the plurality of torque utilization rates and a required steering angle of the plurality of required steering angles with a corresponding estimated error value, obtaining an estimated error value from the table using the torque utilization rate and the required steering angle as inputs, adjusting, based on the estimated error value, the required steering angle, and changing, based on the adjusted steering angle, operation of the vehicle.

The method, wherein the obtaining of the steering error data may comprise measuring and storing a steady-state error at a torque utilization rate for each of the plurality of required steering angles.

The method, wherein the torque utilization rate is a ratio of a tracking torque to a sum of the tracking torque and a driver assist torque, wherein the tracking torque is a torque for following the required steering angle, and wherein the driver assist torque corresponds to a torque generated in response to torque applied by a driver of the vehicle to a steering wheel of the vehicle.

The method, wherein the obtaining of the estimated error value may comprise determining, based on a lateral path of the vehicle, the required steering angle, determining, based on the required steering angle, the estimated error value, and outputting, based on the estimated error value, the adjusted required steering angle.

The method, wherein the estimated error value is retrieved from a lookup table indexed by the required steering angle and a torque utilization rate, and wherein the torque utilization rate is a ratio of the tracking torque to a sum of the tracking torque and the driver assist torque.

The method, further may comprise obtaining an error value by subtracting a measured steering angle from a sum of the required steering angle and the estimated error value, and adjusting, based on the error value, the tracking torque.

According to the present disclosure, an apparatus of a vehicle, the apparatus may comprise a processor and a memory storing at least one instruction that, when executed by the processor communicating with the memory, is configured to cause the apparatus to determine, based on motion data of the vehicle and road information about a lane, a steering angle required for the vehicle, driving autonomously, to follow the lane, obtain an estimated steering error associated with the steering angle, adjust, based on the estimated steering error, the steering angle, output a signal indicating a difference between the adjusted steering angle and a measured steering angle of the vehicle, and control, based on the signal, a steering operation of the vehicle for transitioning from the driving autonomously to manually by a driver of the vehicle.

The apparatus, wherein the at least one instruction, when executed by the processor communicating with the memory, is configured to cause the apparatus to obtain the estimated steering error by retrieving from a lookup table stored in the memory, wherein the lookup table is indexed by the steering angle and a torque utilization rate to store the estimated steering error.

The apparatus, wherein the estimated steering error is obtained after the vehicle reaches a steady steering state.

The apparatus, wherein the estimated steering error is further associated with a torque utilization rate, and wherein the torque utilization rate is a ratio of a tracking torque to a sum of the tracking torque and a driver assist torque.

The apparatus, wherein the tracking torque corresponds to a torque required to follow the steering angle, and wherein the driver assist torque corresponds to a torque amplified based on a torque manually applied by the driver to a steering wheel of the vehicle.

The apparatus, wherein the at least one instruction, when executed by the processor communicating with the memory, is configured to cause the apparatus to adjust, based on the difference between the adjusted steering angle and the measured steering angle, the tracking torque.

The apparatus, wherein the motion data may comprise a speed of the vehicle and a yaw rate of the vehicle, and wherein the road information may comprise a lateral path of the vehicle.

The apparatus, wherein the measured steering angle of the vehicle corresponds to a steering angle detected by a sensor coupled to a steering wheel of the vehicle.

It is to be understood that both the foregoing general description and the following detailed description of the present disclosure are exemplary and explanatory and are intended to provide further explanation of the present disclosure as claimed.

### BRIEF DESCRIPTION OF THE DRAWINGS

The accompanying drawings, which are included to provide a further understanding of the present disclosure and are incorporated in and constitute a part of this application, illustrate example(s) of the present disclosure and together with the description serve to explain the principle of the present disclosure. In the drawings:

FIG. 1 shows an exemplary configuration of an autonomous vehicle according to an example of the present disclosure;

FIG. 2 shows an example of a method of compensating steering error in an autonomous vehicle according to an example of the present disclosure;

FIG. 3 shows an exemplary error of a steering wheel between a required steering angle and a measured steering angle;

FIG. 4 shows an example of a lookup table in which error values according to torque ratios and required steering angles are stored;

FIG. 5 shows an exemplary calculation of a required steering angle by using a torque ratio (utilization rate) and a required steering angle as inputs to a 2D table;

FIG. 6 shows an example of a reduced steering angle error when an improved method is adopted; and

FIG. 7 and FIG. 8 show exemplary effects of autonomous vehicles and method of compensating steering error therein according to a comparative example and an example of the present disclosure.

FIG. 9 shows an example computing system (e.g., a computing device of a vehicle or any other apparatus).

### DETAILED DESCRIPTION OF THE DISCLOSURE

Hereinafter, some examples of the present disclosure will be described in detail with reference to exemplary drawings. In adding reference numerals to components in each figure, it should be noted that the same components are given the same numerals as much as possible even if they are shown in different figures. In addition, in describing examples of the present disclosure, if it is determined that a specific description of a related known configuration or function hinders the understanding of the examples of the present disclosure, the detailed description thereof will be omitted.

In the description of examples according to the present disclosure, a case where an element is described as being formed “on or under” of another element includes both a case where the two elements are directly in contact with each other and a case where one or more other elements are formed between the two elements. In addition, the expression of “on or under” may include the meaning of not only the upward direction but also the downward direction based on one element.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

The term “module” or “unit” used in the specification means a software and/or hardware component, and the “module” or “unit” performs certain operations/functions/roles. However, the “module” or “unit” is not construed as being limited to software or hardware. The “module” or “unit” may be configured to be in an addressable storage medium or to execute one or more processors. Therefore, as an example, the “module” or “unit” may include at least one of components such as software components, object-oriented software components, class components, and task components, processes, functions, attributes, procedures, sub-routines, segments of program codes, drivers, firmware, micro-codes, circuits, data, databases, data structures, tables, arrays, or variables. Functions provided in the components, “modules”, or “units” may be combined into a smaller number of components, “modules”, or “units” or further divided into additional components, “modules”, or “units”.

In the present disclosure, the “module” or “unit” may be realized as a processor and a memory. The “processor” should be widely construed to include a general-purpose processor, a central processing unit (CPU), a microprocessor, a digital signal processor (DSP), a microcontroller, a state machine, or the like. In some environments, the “processor” may refer to an application-specific integrated circuit (ASIC), a programmable logic device (PLD), or a field-programmable gate array (FPGA), and the like. For example, the “processor” may refer to a combination of processing devices such as a combination of a DSP and a microprocessor, a combination of a plurality of microprocessors, a combination of one or more microprocessors combined with a DSP core, or any other such combination. Moreover, the “memory” should be widely construed to include any electronic component capable of storing electronic information. The “memory” may refer to various types of processor-readable medium such as a random access memory (RAM), a read only memory (ROM), a non-volatile random access memory (NVRAM), a programmable read only memory (PROM), an erasable programmable read only memory (EPROM), an electrically erasable programmable read only memory (EEPROM), a flash memory, a magnetic or optical data storage device, and registers. When the processor can read information from a memory and/or record the information in the memory, the memory may be in a state of electronic communication with a processor. Memory integrated into a processor is in a state of electronic communication with the processor.

The one or more features described herein may be provided as a computer program stored in a computer-readable recording medium in order to be executed on a computer. The medium may either continuously store a computer-executable program or temporarily store the program for execution or download. Furthermore, the medium may be a variety of recording or storage means in the form of a single hardware device or multiple combined hardware devices, and is not limited to media directly connected to some computer system but may also be distributed across a network. Examples of such media include magnetic media such as a hard disk, a floppy disk, or a magnetic tape, optical recording media such as a CD-ROM or a DVD, magneto-optical media such as a floptical disk, and a ROM, RAM, or flash memory, among others, configured to store program instructions. Additional examples of such media include media or storage media that are managed by an app store that distributes applications or by various other sites or servers that provide or distribute software.

In a hardware implementation, processing units used for performing the techniques may be implemented within one or more ASICs, DSPs, digital signal processing devices, programmable logic devices, field-programmable gate arrays, processors, controllers, microcontrollers, microprocessors, electronic devices, or computers or combinations thereof designed to perform the functions described in the present disclosure.

At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver when the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein.

One or more features associated with autonomous driving control may be activated based on configured autonomous driving control setting(s) (e.g., based on at least one of: an autonomous driving classification, a selection of an autonomous driving level for a vehicle, etc.). Based on one or more features (e.g., feature of compensating steering error) described herein, an operation of the vehicle may be controlled. The vehicle control may include various operational controls associated with the vehicle (e.g., autonomous driving control, sensor control, braking control, braking time control, acceleration control, acceleration change rate control, alarm timing control, forward collision warning time control, etc.). One or more auxiliary devices (e.g., engine brake, exhaust brake, hydraulic retarder, electric retarder, regenerative brake, etc.) may also be controlled, for example, based on one or more features (e.g., feature of compensating steering error) described herein. One or more communication devices (e.g., a modem, a network adapter, a radio transceiver, an antenna, etc., that is capable of communicating via one or more wired or wireless communication protocols, such as Ethernet, Wi-Fi, near-field communication (NFC), Bluetooth, Long-Term Evolution (LTE), 5G New Radio (NR), vehicle-to-everything (V2X), etc.) may also be controlled, for example, based on one or more features (e.g., feature of compensating steering error) described herein.

Minimum risk maneuver (MRM) operation(s) may also be controlled, for example, based on one or more features (e.g., feature of compensating steering error) described herein. A minimal risk maneuvering operation (e.g., a minimal risk maneuver, a minimum risk maneuver) may be a maneuvering operation of a vehicle to minimize (e.g., reduce) a risk of collision with surrounding vehicles in order to reach a lowered (e.g., minimum) risk state. A minimal risk maneuver may be an operation that may be activated during autonomous driving of the vehicle when a driver is unable to respond to a request to intervene. During the minimal risk maneuver, one or more processors of the vehicle may control a driving operation of the vehicle for a set period of time.

Biased driving operation(s) may also be controlled, for example, based on one or more features (e.g., feature of compensating steering error) described herein. A driving control apparatus may perform a biased driving control. To perform a biased driving, the driving control apparatus may control the vehicle to drive in a lane by maintaining a lateral distance between the position of the center of the vehicle and the center of the lane. For example, the driving control apparatus may control the vehicle to stay in the lane but not in the center of the lane. The driving control apparatus may identify or determine a biased target lateral distance for biased driving control. For example, a biased target lateral distance may comprise an intentionally adjusted lateral distance that a vehicle may aim to maintain from a reference point, such as the center of a lane or another vehicle, during maneuvers such as lane changes. This adjustment may be made to improve the vehicle's stability, safety, and/or performance under varying driving conditions, etc. For example, during a lane change, the driving control system may bias the lateral distance to keep a safer gap from adjacent vehicles, considering factors such as the vehicle's speed, road conditions, and/or the presence of obstacles, etc.

One or more sensors (e.g., IMU sensors, camera, LIDAR, RADAR, blind spot monitoring sensor, line departure warning sensor, parking sensor, light sensor, rain sensor, traction control sensor, anti-lock braking system sensor, tire pressure monitoring sensor, seatbelt sensor, airbag sensor, fuel sensor, emission sensor, throttle position sensor, inverter, converter, motor controller, power distribution unit, high-voltage wiring and connectors, auxiliary power modules, charging interface, etc.) may also be controlled, for example, based on one or more features (e.g., feature of compensating steering error) described herein. An operation control for autonomous driving of the vehicle may include various driving control of the vehicle by the vehicle control device (e.g., acceleration, deceleration, steering control, gear shifting control, braking system control, traction control, stability control, cruise control, lane keeping assist control, collision avoidance system control, emergency brake assistance control, traffic sign recognition control, adaptive headlight control, etc.).

An autonomous driving level and/or autonomous driving activation/deactivation may also be controlled, for example, based on one or more features (e.g., feature of compensating steering error) described herein. A driving control apparatus may perform an autonomous driving level control (e.g., a change of an autonomous driving level, a change of a required user attentiveness, etc.) or cause deactivation of an autonomous driving operation. For example, by changing the required user attentiveness, the driver may be required to place his/her hands on the driving wheel more often (e.g., at least once in a threshold time period, such as five second, 30 seconds, 1 minute, etc.). By changing the required user attentiveness, the driver may be required to look ahead more often (e.g., at least once in a threshold time period, such as five second, 30 seconds, 1 minute, etc.). By changing the autonomous driving level, one or more video contents may not be displayed on a display of the vehicle.

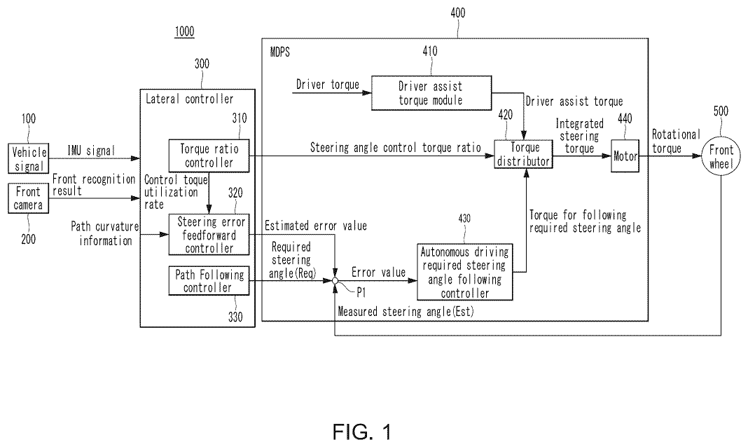

FIG. 1 shows an exemplary configuration of an autonomous vehicle according to an example of the present disclosure. Hereinafter, the configuration of the autonomous vehicle according to an example of the present disclosure will be described with reference to FIG. 1.

When a lateral controller 300 transmits data for changing the steering angle of the vehicle based on a vehicle signal 100 and a signal input from a front camera 200, a steering device such as a motor driven power steering (MDPS) 400 generates a rotational torque (e.g., to initiate a lane change, follow a curved path, or avoid an obstacle, etc.) to drive front wheels 500 in the lateral direction such that the autonomous vehicle 1000 according to the present example may move in the lateral direction.

The detailed description is as follows.

The vehicle signal 100 may carry a motion signal of the vehicle to the lateral controller 300, and for example, the motion signal of the vehicle may be an inertial measurement unit (IMU) signal (e.g., acceleration, angular velocity, yaw rate, or roll rate, etc.). When the vehicle undergoes a movement such as a rotation, an IMU signal may be generated and transmitted to the lateral controller 300. Such a signal may include a yaw rate, lateral acceleration, or angular velocity, etc.

An external sensor such as the front camera 200 transmits a result of object recognition or road condition detection in front of the vehicle to the lateral controller 300. The external sensor may transmit a result of recognizing a preceding vehicle (e.g., a slow-moving car, a merging vehicle, or a braking vehicle, etc.) or an obstacle in front of the vehicle (e.g., a fallen object, a pedestrian, or a construction barrier, etc.) to the lateral controller 300.

The lateral controller 300 may include a torque ratio controller 310, a steering error feedforward controller 320, and a path following controller 330. These components may operate in cooperation to generate a steering output that improves both tracking accuracy and driver comfort.

The torque ratio controller 310 may transmit a control torque utilization rate to the steering error feedforward controller 320 and also transmit the aforementioned result of recognizing the front of the vehicle to the steering error feedforward controller 320 as path curvature information (e.g., curvature of a highway bend, entry into a roundabout, or curvature near a lane split, etc.).

The control torque utilization rate may also be called a torque utilization rate or a torque ratio, and is defined as follows.

Control torque utilization rate=torque for following required steering angle/(torque for following required steering angle+driver assist torque)

Here, the driver assist torque means a torque for turning the vehicle applied by a driver through the steering wheel (e.g., during lane changes, obstacle avoidance, or manual corrections, etc.), and the torque for following a required steering angle is a torque for turning the vehicle generated by the autonomous driving system of the vehicle (e.g., for lane keeping, path tracking, or curvature following, etc.). For example, if the vehicle is completely autonomous and thus the driver does not apply force to the steering wheel, the control torque utilization rate is 1. Conversely, if the driver is fully in control with no contribution from the autonomous system, the torque utilization rate becomes 0.

The path curvature information is curvature information of a path along which the vehicle will travel, and means curvature information of a path of the vehicle when changing paths to avoid an object recognized in front of the vehicle or when changing paths for other convenience functions (e.g., lane keeping, merging into traffic, exiting a highway, or bypassing a parked vehicle, etc.).

The MDPS 400 may include a driver assist torque module 410, a torque distributor 420, an autonomous driving required steering angle following controller 430, and a motor 440 (e.g., an electric motor configured to apply steering torque, etc.).

The torque distributor 420 may receive a driver assist torque from the driver assist torque module 410. In FIG. 1, the driver torque is a torque applied by the driver by turning the steering wheel, and the driver assist torque means a force that enables the MDPS 400 to smoothly move the front wheels when the driver applies force to the steering wheel for operating the front wheels. For example, the driver assist torque may be amplified by power assistance to reduce the effort needed by the driver. Here, the vehicle may be a front-wheel drive vehicle, and if the vehicle is a rear-wheel drive vehicle, the driver assist torque may mean a force that enables the rear wheels to be smoothly moved for operating the rear wheels.

The torque distributor 420 may also receive a steering angle control torque ratio from the torque ratio controller 310. The steering angle control torque ratio may vary depending on the magnitude of the torque applied to the steering wheel by the driver and the curvature of the road on which the vehicle is traveling (e.g., sharp turns, long sweeping curves, or lane bends, etc.).

The torque distributor 420 may also receive a torque for following a required steering angle from the autonomous driving required steering angle following controller 430, and the autonomous driving required steering angle following controller 430 may receive an error value (e.g., representing a predicted deviation due to mechanical delay, road curvature mismatch, or steering compliance, etc.). Here, the “error value” may be a value obtained by subtracting a measured steering angle Est (e.g., obtained from a steering angle sensor mounted on the steering column or front wheels, etc.) from the sum of a required steering angle Req, which is input from the path following controller 330 and an estimated error value that is input from the steering error feedforward controller 320. For example, the aforementioned error value is defined as follows to compensate for lag or system inaccuracies in steering control.

Error value=(required steering angle+estimated error value)−measured steering angle

Here, the measured steering angle may be a steering angle measured from the front wheels 500 of the vehicle (e.g., using a steering angle sensor integrated with the steering column or wheel hub, etc.).

As shown in FIG. 1, the measured steering angle measured obtained from the front wheels of the vehicle is fed back, the error value is calculated from the required steering angle, the estimated error value, and the measured steering angle at a processing point P1 (e.g., within a signal processing path of the autonomous driving required steering angle following controller 430, etc.), and the calculated error value may be transmitted to the autonomous driving required steering angle following controller 430 to allow real-time correction of steering torque during autonomous or cooperative driving modes.

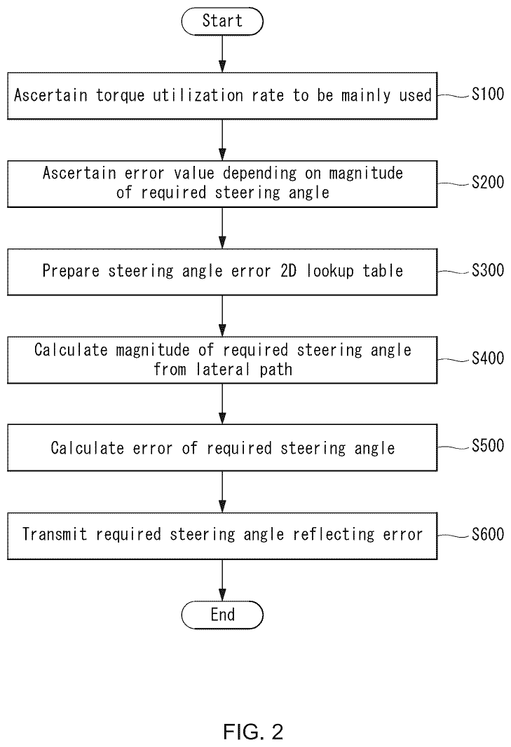

FIG. 2 shows an example of a method of compensating steering error in an autonomous vehicle according to an example of the present disclosure. Referring to FIG. 2, the method of compensating steering error in an autonomous vehicle according to the present disclosure may include a step of collecting steering error data (e.g., during autonomous driving under varied road curvatures or speeds, etc.), a step of preparing a table according to torque ratios and required steering angles on the basis of the collected steering error data (e.g., forming a 2D lookup table using interpolation or empirical mapping, etc.), and a step of calculating a torque utilization rate (e.g., based on a ratio of autonomous torque to total steering torque, etc.) and a required steering angle and using the same as inputs to the table to derive a required steering angle (e.g., for feedforward correction, lookup-based compensation, or predictive adjustment, etc.).

In the step of collecting steering error data, a steady-state error at a torque utilization rate intended for primary use (e.g., 0.6 to 0.8 during cooperative driving, etc.) may be measured for each required steering angle and stored (S100), and a specific required steering angle may be measured, stored, and output by the path following controller 330 in FIG. 1 (e.g., during steady-state lane keeping or curved-path tracking, etc.). Here, since there may be little difference in steering performance depending on the speed of the vehicle, error may be measured at any speed above 20 kph (kilometers per hour). For example, data may be collected during steady cruising, cornering maneuvers, or lane changes above this speed threshold. In particular, the torque utilization rate may be set to an error range of within 20% of the required steering angle (e.g., to ensure predictive accuracy across moderate curvature commands, etc.) such that excellent steering performance is achieved during overriding to take over the driving control of the autonomous vehicle (e.g., by reducing abrupt torque transitions or steering resistance, etc.), and the aforementioned range may be a range in which the driver feels less bothered (e.g., perceives less resistance or abruptness, etc.) when overriding the steering wheel.

In addition, an error value according to the magnitude of the required steering angle may be ascertained (S200). Here, an error value in the torque utilization rate range to be mainly used as described above may be ascertained (e.g., for use in constructing a torque-steering angle-error mapping table, etc.).

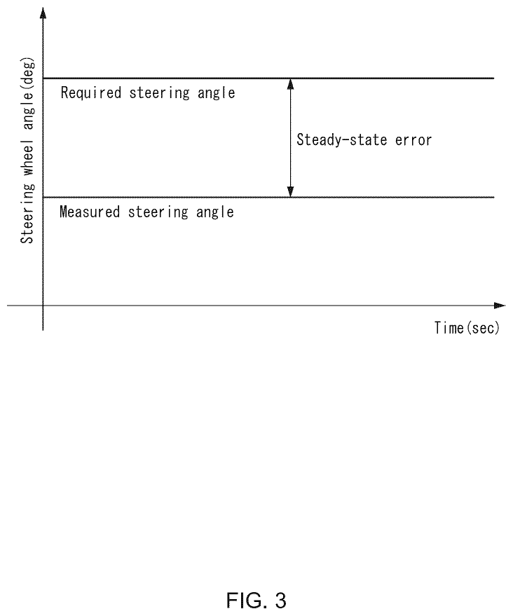

Referring to FIG. 3, the angle (deg) of the steering wheel shows a difference corresponding to the steady-state error, which is the difference between the required steering angle and the measured steering angle (e.g., due to system lag, mechanical compliance, or sensor delay, etc.). In the present example, the range in which the error is within 20% in FIG. 3 may be used for control of the autonomous vehicle (e.g., for dynamic correction, calibration, or smooth transition between autonomous and manual steering, etc.).

In the step of preparing the table (S300), the table may be a lookup table in which values are stored in advance in the form of a table (e.g., as paired entries of torque utilization rate and required steering angle, etc.) in order to omit the process of recalculating steering error dynamically when retrieving a value each time. For example, the table may be prepared as a 2D lookup table such that a value may be retrieved without calculation each time (e.g., using interpolation between required steering angle and torque ratio inputs to predict error, etc.).

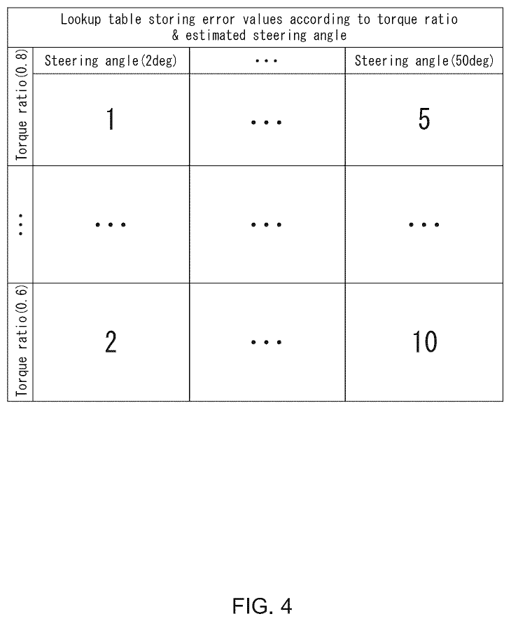

FIG. 4 shows an example of a lookup table in which error values according to torque ratios and required steering angles are stored. In FIG. 4, where error values according to torque ratios and required steering angles are stored in the above-described manner, for example, when the torque ratio is 0.8 and the steering angle is 2 degrees (°), the estimated error is 1 degree (e.g., indicating how much correction should be added to the steering command, etc.).

The step of calculating the torque utilization rate and the required steering angle and using the same as inputs to the 2D table to derive a required steering angle may include step S400 of calculating the magnitude of a required steering angle from a lateral path, step S500 of calculating an error of the required steering angle, and step S600 of reflecting the calculated error in the required steering angle and transmitting the same (e.g., to a steering actuator or torque distributor for execution, etc.).

First, the process of calculating the magnitude of an estimated required steering angle from a lateral path is described. The required steering angle δ(t)_{pred} may be defined by the following mathematical expression 1 (e.g., derived based on vehicle dynamics and curvature prediction, etc.).

<Mathematical expression 1>

δ(t)_{pred}=(L+Kᵤₛ·Vₓ²)·(CD_{road}·Vₓ·t+C_{road})

Here, t is an estimated time, L is the axle distance of the vehicle, Kᵤₛ is the understeer coefficient, Vₓ is the wheel speed, CD_{road} is the rate of change in the curvature of a path along which the vehicle will travel, and C_{road} is the curvature of the path along which the vehicle will travel (e.g., derived from a lane detection algorithm or a high-definition map, etc.).

The axle distance L of the vehicle is the distance between the rotation axis of the front wheels and the rotation axis of the rear wheels of the vehicle e.g., typically measured from the center of the front axle to the center of the rear axle, etc.). The understeer coefficient Kᵤₛ is a coefficient that indicates the degree of understeer when the vehicle turns (e.g., representing how much additional steering input is needed to maintain a curved path at higher speeds, etc.). A case in which the vehicle turns less than a degree to which the driver attempts to turn the vehicle with the steering wheel is called understeer, which is the opposite phenomenon to oversteer in which the vehicle turns more than a degree to which the driver attempts to turn the vehicle with the steering wheel (e.g., common in rear-wheel drive sports cars, etc.).

The estimated time t indicates seconds required for use by using the aforementioned wheel speed Vₓ, rate of change CD_{road} in the curvature of the path, and curvature C_{road} of the path (e.g., allowing prediction of the future steering need along the anticipated driving trajectory, etc.).

Then, an error of the estimated required steering angle is calculated according to mathematical expression 1 using the steering angle error 2D lookup table that uses the torque utilization rate and the estimated required steering angle as inputs (e.g., to pre-compensate for system lag, actuation delay, or dynamic variations in steering response, etc.).

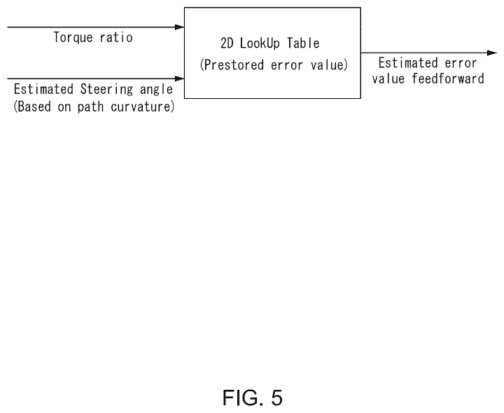

FIG. 5 shows an exemplary calculation of a required steering angle by using a torque ratio (utilization rate) and a required steering angle as inputs to the above-described 2D table (e.g., to retrieve a corresponding steering error for feedforward correction, etc.).

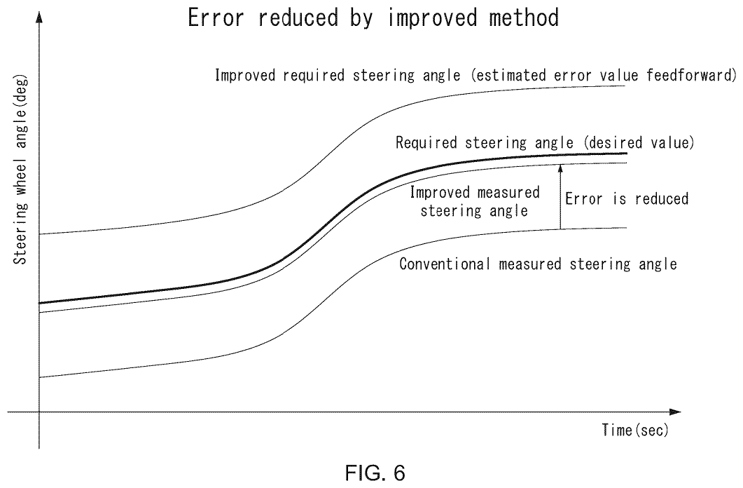

FIG. 6 shows an example of a reduced steering angle error when an improved method is adopted.

It may be ascertained that an improved required steering angle to which an estimated error value is fed forward is reflected in a conventional measured steering angle and is converted into an improved measured steering angle, and thus the difference between the improved measured steering angle and the required steering angle is reduced (e.g., resulting in more accurate steering alignment with the desired path, especially under partial torque blending conditions, etc.). The error is reduced by the amount indicated by the arrow (e.g., in FIG. 6, showing a measurable improvement in tracking accuracy, etc.).

Then, the required steering angle in which the calculated error has been reflected may be transmitted (e.g., to a steering actuator, torque distributor, or control logic for execution, etc.). For example, when the required steering angle Req is transmitted from the path following controller 330 in FIG. 1, the error value, which is obtained by subtracting the measured steering angle Est from the sum of the required steering angle Req and the estimated error value (e.g., estimated required steering angle error value, derived from the 2D lookup table based on torque ratio and predicted steering demand, etc.) input from the steering error feedforward controller 320, may be transmitted to the autonomous driving required steering angle following controller 430 for torque compensation and steering correction.

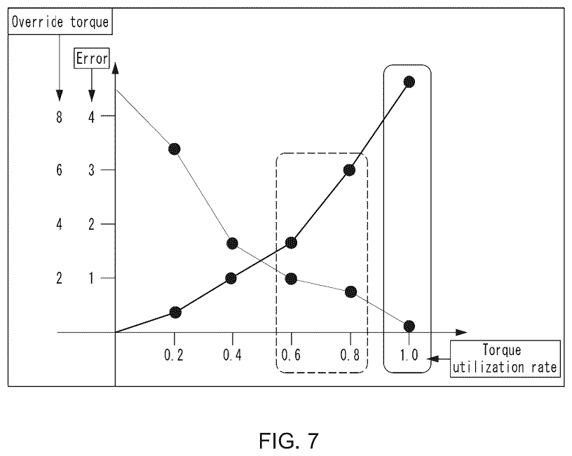

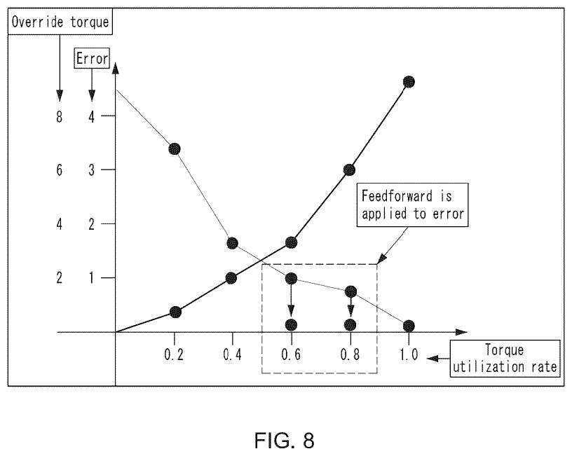

FIG. 7 and FIG. 8 show the effects of autonomous vehicles and the corresponding steering error compensation methods thereof according to a comparative example and an example of the present disclosure (e.g., showing improvements in steering accuracy and override smoothness, respectively, etc.).

It may be ascertained from FIG. 7 that, as the torque utilization rate increases from 0.2 to 1.0, the error decreases from 3.5 to 0 (zero), and the override torque increases from 0.5 to 9 (e.g., indicating that while control accuracy improves, the effort required by the driver to override the system also becomes greater, etc.). For example, if the torque utilization rate is lowered to 0.6 to 0.8, as in the area indicated by the dotted line, the steering wheel becomes softer, which may give the driver more natural feeling when steering (e.g., reduced resistance and smoother input, etc.), but the steering angle control performance may deteriorate, which may cause the vehicle to deviate from a path desired by the autonomous driving system (e.g., due to insufficient torque to maintain precise lateral tracking, etc.). In addition, if the torque utilization rate is increased to 1.0, as in the area indicated by the solid line, the steering angle control performance may improve (e.g., enabling more accurate path tracking, especially on curved roads, etc.), but the override force may become excessive, which may cause the driver to feel uncomfortable when adjusting the steering wheel (e.g., requiring greater effort to regain control during manual override, etc.).

Here, natural steering feeling means that the steering wheel turns smoothly when the driver turns the steering wheel (e.g., without unexpected resistance or delay, etc.). During normal driving, the “driver assist torque” is applied and thus the steering wheel moves smoothly, but during autonomous driving, “torque for following a required steering angle” is generated, and thus a torque different from the torque intended by the driver is generated, which may cause a sense of discomfort or interference (e.g., as if the vehicle is resisting the driver's input, etc.).

In addition, override torque refers to the force applied by the driver to transfer control during autonomous driving, and means that the driver releases the autonomous driving control system through a method such as applying force to the steering wheel (e.g., by turning it with sufficient resistance against the system's active torque, etc.). For example, when a system such as Lane Following Assist (LFA) or Highway Driving Assist 2 (HAD2 ) is in operation, if the driver applies a rotational force exceeding a specific force to the steering wheel, the system is released, and the magnitude of the specific force is “override torque” (e.g., typically calibrated to prevent accidental disengagement while allowing intentional takeover, etc.).

In the autonomous vehicle according to an example of the present disclosure illustrated in FIG. 8, the error value is fed forward and thus the error becomes close to 0 at a torque utilization rate of 0.6 to 0.8 (e.g., a balanced range that offers acceptable steering feel and control accuracy, etc.). Here, the reason why the torque utilization rate is applied only in the range of 0.6 to 0.8 is that 0.6 to 0.8 are rates of torque applied for following the required steering angle, and since it is less than 1, there is an error between the required steering angle and the measured steering angle (e.g., due to the influence of partial driver input or actuation delay, etc.). At this time, the error may be made close to 0 by reflecting the estimated error value in advance (e.g., using the 2D lookup table generated during prior calibration steps, etc.).

In the example illustrated in FIG. 8, the error between the required steering angle and the actual steering angle is measured and stored in advance at a torque ratio that enables smooth control of the steering wheel (e.g., a midrange torque utilization ratio such as 0.6 to 0.8, etc.), and the torque for the required steering angle is generated in the autonomous driving required steering angle following controller 430 by reflecting the error value retrieved from the 2D lookup table as illustrated in FIG. 1, thereby providing smooth steering feeling and improving the steering performance (e.g., by reducing or minimizing deviation and enhancing driver comfort during steering override, etc.).

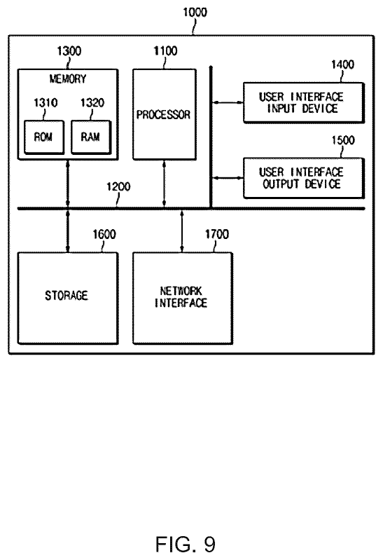

FIG. 9 shows an example computing system (e.g., a computing device of a vehicle or any other apparatus). One or more controllers, processors, etc. described herein, such as one or more components of the vehicle, and any other components and devices disclosed herein, may be implemented by or in the computing system as shown in FIG. 9.

A computing system 1000 may include at least one processor 1100, memory 1300, a user interface input device 1400, a user interface output device 1500, a storage 1600, and a network interface 1700, which are connected with each other via a bus 1200.

The processor 1100 may be a central processing unit (CPU) or a semiconductor device that processes instructions stored in the memory 1300 and/or the storage 1600. Each of the memory 1300 and the storage 1600 may include various types of volatile or nonvolatile storage media. For example, the memory 1300 may include a read-only memory (ROM) and a random-access memory (RAM).

Communication interface(s) (also referred to as communication device(s), communicator(s), communication module(s), communication unit(s), etc.), such as the network interface 1700, may allow software and/or data to be transferred between a device and one or more external devices, and/or between one or more components of a device. Communication interface(s) may include a receiver, a transmitter, a transceiver, a modem, a network interface and/or adapter (such as an Ethernet adapter), a radio transceiver, an antenna, a communication port, a Personal Computer Memory Card International Association (PCMCIA) slot and card, or the like. Software and data transferred via communication interface(s) may be in the form of signals, which may be electronic, electromagnetic, optical, infrared, or other signals capable of being received by communication interface(s). These signals may be provided to communication interface(s) via a communication path of a device, which may be implemented using, for example, wire or cable, fiber optics, a cellular link, a radio frequency (RF) link and/or other communications channels. Communication interface(s) may communicate using one or more communication protocols, such as Ethernet, Wi-Fi, near-field communication (NFC), Infrared Data Association (IrDA), Bluetooth, Bluetooth low energy (BLE), Zigbee, Long-Term Evolution (LTE), 5G New Radio (NR), vehicle-to-everything (V2X), a controller area network (CAN), or a local interconnect network (LIN), etc.

Accordingly, the operations of the method or algorithm described in connection with example embodiment(s) disclosed in the specification may be directly implemented with a hardware module, a software module, or a combination of the hardware module and the software module, which is executed by the processor 1100. The software module may reside on a storage medium (e.g., the memory 1300 and/or the storage 1600) such as RAM, a flash memory, ROM, an erasable and programmable ROM (EPROM), an electrically EPROM (EEPROM), a register, a hard disk drive, a removable disc, or a compact disc-ROM (CD-ROM).

The storage medium may be coupled to the processor 1100. The processor 1100 may read out information from the storage medium and may write information in the storage medium. Alternatively, the storage medium may be integrated with the processor 1100. The processor and storage medium may be implemented with an application specific integrated circuit (ASIC). The ASIC may be provided in a user terminal. Alternatively, the processor and storage medium may be implemented with separate components in the user terminal.

To achieve above objects and other advantages and in accordance with the purpose of the disclosure, as exemplified and broadly described herein, an autonomous vehicle includes a lateral controller configured to receive an IMU signal and a result of recognition of a front of a vehicle and including a torque ratio controller, a steering error feedforward controller, and a path following controller, and a steering device configured to receive an output value of the lateral controller and transmit a rotational torque to front wheels of the vehicle, wherein the steering device includes a torque distributor configured to receive a driver assist torque, a steering angle control torque ratio, and a torque for following a required steering angle, generate an integrated steering torque, and transmit the integrated steering torque to a motor, the torque for following a required steering angle is generated by an autonomous driving required steering angle following controller in the steering device, and an estimated error value of a required steering angle is reflected and input to the autonomous driving required steering angle following controller.

The torque ratio controller may transmit a control torque utilization rate to the steering error feedforward controller and transmit the steering angle control torque ratio to the torque distributor.

The steering error feedforward controller may receive path curvature information and feed forward an estimated error value.

The path following controller may output a required steering angle.

The error value input to the autonomous driving required steering angle following controller may be a value obtained by subtracting a measured steering value from the front wheels of the vehicle from a sum of the required steering angle and the estimated error value.

The driver assist torque may be output from a driver assist torque module when a torque applied to a steering wheel by a driver of the vehicle is input to the driver assist torque module.

In another example of the present disclosure, a method of compensating a steering error in an autonomous vehicle includes collecting steering error data, preparing a table according to torque utilization rates and required steering angles on the basis of the collected steering error data, and calculating a required steering angle by using a torque utilization rate and a required steering angle as inputs to the table.

The collecting steering error data may include measuring and storing a steady-state error at a torque utilization rate to be mainly used for each required steering angle.

In the preparing a 2D lookup table, linear interpolation may be applied as interpolation between break points.

The required steering angle δ(t)_{pred} is defined by δ(t)_{pred}=(L+Kᵤₛ·Vₓ²)·(CD_{road}·Vₓ·t+C_{road}), where t is an estimated time, L is an axle distance of the vehicle, Kᵤₛ is the understeer coefficient, Vₓ is a wheel speed, CD_{road} is a rate of change of the curvature of a path on which the vehicle will travel, and C_{road} is the curvature of the path along which the vehicle will travel.

The calculating a required steering angle by using a torque utilization rate and a required steering angle as inputs to the table may include calculating a magnitude of a required steering angle estimated from a lateral path of the vehicle, and calculating an error of the estimated required steering angle.

The method may further include transmitting a required steering angle reflecting the error of the estimated required steering angle.

In the autonomous vehicle and the method of compensating steering error thereof according to the above-described example of the present disclosure, an error between a required steering angle and an actual steering angle is measured and stored in advance at a torque ratio that allows smooth control of the steering wheel, and the error value is reflected in advance to generate a torque for following the required steering angle in the autonomous driving required steering angle following controller, thereby improving the steering performance while providing smooth steering feeling.

The required steering angle is estimated from the lateral path of the vehicle, and when the required steering angle reflecting an estimated error of the required steering angle is transmitted, an error value, obtained by subtracting a measured steering angle from the sum of the required steering angle and the estimated error value, may be transmitted to the autonomous driving required steering angle following controller.

In the above, even though all the components constituting the examples of the present disclosure have been described as being combined as one or operating in combination, the present disclosure is not necessarily limited to these examples. For example, within the scope of the purpose of the present disclosure, one or more of the components may be selectively combined and operated. In addition, the term “comprise”, “include”, or “have” described herein should be interpreted not to exclude other elements but to further include such other elements since the corresponding elements may be included unless mentioned otherwise. All terms including technical or scientific terms have the same meanings as generally understood by a person having ordinary skill in the art to which the present disclosure pertains unless mentioned otherwise. Generally used terms, such as terms defined in a dictionary, should be interpreted to coincide with meanings of the related art from the context. Unless differently defined in the present disclosure, such terms should not be interpreted in an ideal or excessively formal manner.

The above description is merely an exemplary description of the technical idea of the present disclosure, and those skilled in the art to which the present disclosure pertains may make various modifications and variations without departing from the essential characteristics of the present disclosure. Accordingly, the examples of the present disclosure are not intended to limit the technical idea of the present disclosure but to explain the same, and the scope of the technical idea of the present disclosure is not limited by these examples. The scope of protection of the present disclosure should be interpreted by the claims below, and all technical ideas within the equivalent scope should be interpreted as being included in the scope of the rights of the present disclosure.

What is claimed is:

1. An apparatus of a vehicle, the apparatus comprising:
a processor; and
a memory storing at least one instruction that, when executed by the processor communicating with the memory, is configured to cause the apparatus to:
obtain a motion signal of the vehicle and recognition information of a front area of the vehicle,
determine, based on the motion signal and the recognition information, a required steering angle for the vehicle and an estimated error value in the required steering angle,
generate, based on the estimated error value, a tracking torque, wherein the tracking torque is a torque for the vehicle to follow the required steering angle,
obtain a driver assist torque and a steering angle control torque ratio,
generate an integrated steering torque based on the tracking torque, the driver assist torque, and the steering angle control torque ratio, and
during a driving operation of the vehicle, provide the integrated steering torque as a rotational torque to front wheels of the vehicle.

2. The apparatus of claim 1, wherein the steering angle control torque ratio is used to adjust a contribution ratio between the tracking torque and the driver assist torque for generating the integrated steering torque.

3. The apparatus of claim 1, wherein the estimated error value is generated based on path curvature information obtained from the recognition information of the front area of the vehicle, and wherein the required steering angle is determined based on the path curvature information and the motion signal of the vehicle.

4. The apparatus of claim 3, wherein the estimated error value is retrieved from a lookup table indexed by the required steering angle and a torque utilization rate, and the torque utilization rate is a ratio of the tracking torque to a sum of the tracking torque and the driver assist torque.

5. The apparatus of claim 1, wherein the at least one instruction that, when executed by the processor communicating with the memory, is configured to cause the apparatus to:
obtain an error value by subtracting a steering angle value from a sum of a value of the required steering angle and the estimated error value, wherein the steering angle value is measured from front wheels of the vehicle, and
adjust, based on the error value, the tracking torque.

6. The apparatus of claim 1, wherein the driver assist torque is obtained based on a torque applied to a steering wheel of the vehicle by a driver of the vehicle.

7. A method performed by an apparatus of a vehicle, the method comprising:
obtaining steering error data of the vehicle, wherein the steering error data is associated with a plurality of torque utilization rates and a plurality of required steering angles;
generating, based on the obtained steering error data, a table, wherein the table associates a torque utilization rate of the plurality of torque utilization rates and a required steering angle of the plurality of required steering angles with a corresponding estimated error value;
obtaining an estimated error value from the table using the torque utilization rate and the required steering angle as inputs;
adjusting, based on the estimated error value, the required steering angle; and
changing, based on the adjusted steering angle, operation of the vehicle.

8. The method of claim 7, wherein the obtaining of the steering error data comprises measuring and storing a steady-state error at a torque utilization rate for each of the plurality of required steering angles.

9. The method of claim 7, wherein the torque utilization rate is a ratio of a tracking torque to a sum of the tracking torque and a driver assist torque, wherein the tracking torque is a torque for following the required steering angle, and wherein the driver assist torque corresponds to a torque generated in response to torque applied by a driver of the vehicle to a steering wheel of the vehicle.

10. The method of claim 7, wherein the obtaining of the estimated error value comprises:
determining, based on a lateral path of the vehicle, the required steering angle;
determining, based on the required steering angle, the estimated error value; and
outputting, based on the estimated error value, the adjusted required steering angle.

11. The method of claim 9, wherein the estimated error value is retrieved from a lookup table indexed by the required steering angle and a torque utilization rate, and wherein the torque utilization rate is a ratio of the tracking torque to a sum of the tracking torque and the driver assist torque.

12. The method of claim 9, further comprising:
obtaining an error value by subtracting a measured steering angle from a sum of the required steering angle and the estimated error value; and
adjusting, based on the error value, the tracking torque.

13. An apparatus of a vehicle, the apparatus comprising:
a processor; and
a memory storing at least one instruction that, when executed by the processor communicating with the memory, is configured to cause the apparatus to:
determine, based on motion data of the vehicle and road information about a lane, a steering angle required for the vehicle, driving autonomously, to follow the lane,
obtain an estimated steering error associated with the steering angle,
adjust, based on the estimated steering error, the steering angle,
output a signal indicating a difference between the adjusted steering angle and a measured steering angle of the vehicle, and
control, based on the signal, a steering operation of the vehicle for transitioning from the driving autonomously to manually by a driver of the vehicle.

14. The apparatus of claim 13, wherein the at least one instruction, when executed by the processor communicating with the memory, is configured to cause the apparatus to obtain the estimated steering error by retrieving from a lookup table stored in the memory, wherein the lookup table is indexed by the steering angle and a torque utilization rate to store the estimated steering error.

15. The apparatus of claim 13, wherein the estimated steering error is obtained after the vehicle reaches a steady steering state.

16. The apparatus of claim 13, wherein the estimated steering error is further associated with a torque utilization rate, and wherein the torque utilization rate is a ratio of a tracking torque to a sum of the tracking torque and a driver assist torque.

17. The apparatus of claim 16, wherein the tracking torque corresponds to a torque required to follow the steering angle, and wherein the driver assist torque corresponds to a torque amplified based on a torque manually applied by the driver to a steering wheel of the vehicle.

18. The apparatus of claim 16, wherein the at least one instruction, when executed by the processor communicating with the memory, is configured to cause the apparatus to adjust, based on the difference between the adjusted steering angle and the measured steering angle, the tracking torque.

19. The apparatus of claim 13, wherein the motion data comprises a speed of the vehicle and a yaw rate of the vehicle, and wherein the road information comprises a lateral path of the vehicle.

20. The apparatus of claim 13, wherein the measured steering angle of the vehicle corresponds to a steering angle detected by a sensor coupled to a steering wheel of the vehicle.
